(19) United States
(12) Patent Application Publication
(10) Pub. No.: US 2017/0252687 A1
(43) Pub. Date: Sep. 7, 2017

(54) AIR DISTRIBUTING MANIFOLD FOR A HYDROVAC TANK

(71) Applicant: TORNADO GLOBAL HYDROVACS LTD., Calgary (CA)

(72) Inventors: Robin Michael MCCAFFREY, Red Deer (CA); Bill ROLLINS, Calgary (CA)

(21) Appl. No.: 15/060,549

(22) Filed: Mar. 3, 2016

(51) Int. Cl. B01D 45/02; E02F 3/90; E02F 3/88

(52) U.S. Cl. CPC B01D 45/02; E02F 3/8816; E02F 3/90

(57) ABSTRACT

The present invention provides an air distributing manifold that is positioned and operative within the interior of the debris holding tank of the hydrovac system. The air distributing manifold can be configured to aid in the recirculating of the airflow within the debris holding tank prior to exit from the tank, thereby enhancing the precipitation of entrained particulates within the air stream.

### FIELD OF THE INVENTION

The present invention pertains to the field of hydrovac tanks and in particular to an air distributing manifold for a hydrovac tank.

### BACKGROUND

Hydro-Excavation is a process where high pressure water is used to loosen soil, rocks, clay, gravel and other earth material while it is continually “sucked up” into a debris tank for later disposal.

As early as 1960 catch basin cleaners were adapted for hydro-excavation but the technology was crude. Many advancements in the technology for hydro-excavation were adapted and refined from industrial scale projects in the oil and gas sector. Because of the cold climate and difficult working conditions “daylighting” buried lines with high pressure hot water and. removing the debris by suction was proving an indispensable tool in the field. In the decades of the 70's and 80's, modified vacuum trucks and sewer cleaners were adapted for use as suction excavators and by the 90's there was a commercial demand for hydro-excavation machines for industrial, municipal and commercial use. The increasing demand for non-destructive digging and necessary improvements in the field of worker safety are at least some of the driving forces behind the growth of the vacuum excavation sector.

A typical hydrovac system includes a vacuum source, a debris storage unit and a water storage unit, wherein the vacuum source is interconnected to the debris storage unit. Some hydrovac systems further include filtration systems, for example a cyclone filter which can be used to remove debris from the air travelling with the vacuumed material into the debris storage unit prior to reentry of this air into the vacuum source.

In a hydrovac equipment context, soil and aggregates at a selected ground location are cut by hydraulic water jet, with the resulting debris being entrained into an airflow created by an air pump. Most of the debris typically is deposited into a debris holding tank. This deposition of the debris is done when the incoming air stream enters the debris holding tank as the velocity of the air slows down due to a large increase in working volume. By slowing down the air stream, debris entrained within the air stream separates and collects in the debris holding tank. After exiting the debris holding tank, further purification of the airflow is typically required through the use of subsequent cyclones and/or air filters. It is necessary to purify the air stream in order to ensure reliable operation of the air pump. However additional air purification comes at a cost, both in added equipment cost as well as a cost to the performance and fuel efficiency of the operating equipment.

Therefore there is a need for a new air filtering device for a hydrovac system that overcomes one or more of the problems in the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an air distributing manifold for a hydrovac system. In accordance with an aspect of the present invention, there is provided an air distributing manifold for a hydrovac tank having an entry aperture and an exit aperture, the air distributing manifold comprising a lower plate having a length and a width, wherein the width decreases over the length of the lower plate. The air distributing manifold further includes two side plates coupled to opposite sides of the lower plate, the side plates configured to compress air flowing along the length of the lower plate, wherein a narrow end of the lower plate is positioned proximate to the exit aperture and the lower plate extends into the interior of the hydrovac tank.

### BRIEF DESCRIPTION OF THE FIGURES

FIG. 1 illustrates an elevation view of a hydrovac tank having an air distributing manifold in accordance with embodiments of the present invention, installed therein.

FIG. 2 illustrates a sectional view of the air distributing manifold in accordance with embodiments of the present invention, wherein the sectional view is taken along line A-A illustrated in FIG. 1.

### DETAILED DESCRIPTION OF THE INVENTION

It is noted that by slowing down the air stream upon entry into the larger working volume of the debris holding tank, debris entrained within the air stream separates and collects in the debris holding tank. However after exiting the debris holding tank, further purification of the airflow is typically required in order to provide air with minimal entrained debris which may impact the operation of the air pump associated with the hydrovac system. As such, subsequent to exiting the debris holding tank, the airflow typically travels to cyclones and/or air filters for further debris removal. As noted above, it is necessary to purify the air stream in order to ensure reliable operation of the air pump, however, this additional air purification comes at a cost. This cost can be in both the requirement of additional systems and equipment being required in the hydrovac system, as well as cost to performance and fuel efficiency of the hydrovac system.

Accordingly a new technique for enhancing debris removal from the air flow while the airflow is present within the debris holding tank is desired. In accordance with embodiments of the present invention, an air distributing manifold is positioned and operative within the interior of the debris holding tank of the hydrovac system.

According to embodiments, the air distributing manifold is configured to aid in the recirculating of the airflow within the debris holding tank prior to exit from the tank, thereby enhancing the precipitation of entrained particulates within the air stream, In this manner, the air distributing manifold is configured to cause the air flow to recirculate in the debris holding tank thus providing a virtual barrier between the incoming debris and the outgoing air. According to embodiments, the air distributing manifold can cause the outgoing air to slow down sufficiently such that substantially all of the entrained particulates drop out of the air flow in advance of air exiting the debris holding tank.

In a hydrovac equipment context, soil and aggregates are loaded into a storage tank in order to be moved to another location, while a second tank stores water which is used to cut into the ground. Plural hydrovac systems include separate water and debris storage units which are manufactured as separate entities and mounted onto a vehicle. Other hydrovac systems include a tank device which has been divided into two compartments, wherein a first compartment water can be used to stored for use at the excavation location and a second compartment can be used for deposition of the debris upon vacuuming from the excavation location. This configuration of tank is typically referred to as a dual function tank.

These dual function tanks typically include a divider wall and/or floor which forms a harrier separating the debris storage compartment from the clean water supply compartment. It is known that these separating barriers are typically made with flat sheet metal with adequate reinforcement and structural components to withstand the vacuum pressure generated in the debris storage compartment as well as and the impact of the debris upon entry into debris storage compartment. It is common for these barriers to include a sloped floor section to aid in removal of the debris from the tank.

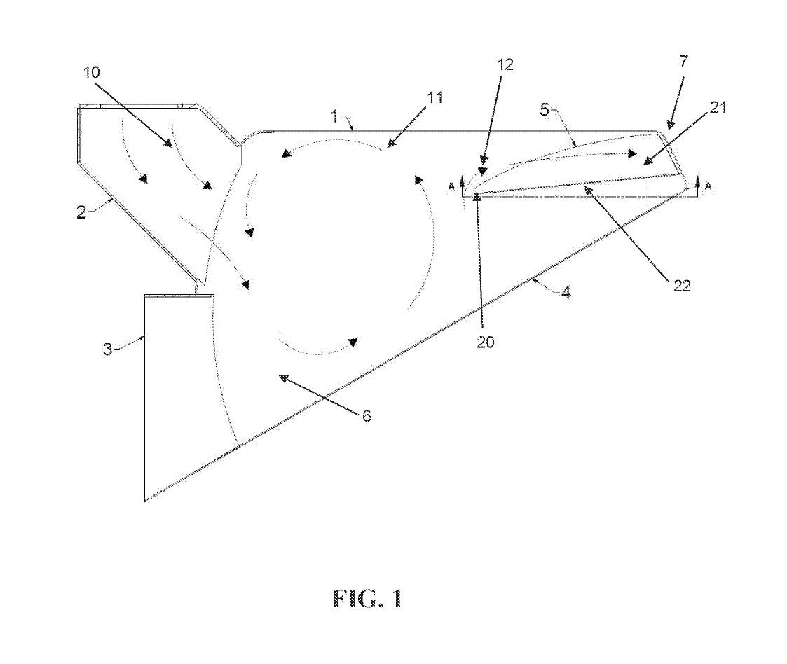

FIG. 1 illustrates a side view of a hydrovac tank which includes an air distributing manifold configured in accordance with embodiments of the present invention. The hydrovac tank I includes a turret mount 2, which is a location of an opening defined in the tank through which material can be loaded into the debris storage compartment 6 of the hydrovac tank. A boom and hose can he attached to the turret mount wherein the hose is guided to the desired excavation location by the boom. During operation, a vacuum source will be activated such that the debris storage compartment is depressurized causing a suction force to be created at the opening of the pipe such that material in the proximity of the opening of the pipe will be sucked up and subsequently deposited in the debris storage compartment. The hydrovac system further includes a dumping door frame 3 to which a door is pivotally and sealingly connected. The opening defined by the dumping door frame provides a location from which material can be removed from the debris storage compartment. In addition, the air flowing through the debris storage compartment exits via air exit aperture 7, proximate to which is positioned an air distributing manifold 5 in accordance with embodiments of the present invention. The hydrovac tank further includes a water storage compartment, which is separated from the debris storage compartment by the sloped floor 4, and this water storage compartment can be positioned below the debris storage compartment and can provide a volume within which water can be stored and used during the vacuuming process.

According to embodiments, the air distributing manifold is positioned below the air exit aperture thereby inhibiting the air flow which enters the debris holding tank and travels along the sloped floor from exiting out of the air exit aperture. By limiting this air flow possibility the air distributing manifold is increasing the probability of the recirculation of the air flow within the debris holding tank, thus enhancing the deceleration of the air flow. Moreover by decelerating the air flow, the particulate that is entrained within the air flow has a higher probability of precipitation from the air flow. With further reference to FIG. 1, the travel of the air flow into the tank 10 and the subsequent recirculation 11 is illustrated.

According to embodiments, the air distributing manifold includes a lower plate and side plates coupled thereto, wherein the lower plate is positioned proximate to the air exit aperture in the debris holding tank. An embodiment of the air distributing manifold is illustrated in FIG. 1, two side plates 21 are positioned on opposite sides of the lower plate 22 such that the air filtering device essentially forms a pan, which may he considered to he similar to the shape of a dust pan. The lower plate can be oriented such that it has a slope associated therewith wherein this slope is configured to be at its highest proximate to the air exit aperture and sloping downwards away from this position. This sloped nature of the air distributing manifold is illustrated in FIG. 1. The air flow which is recirculating 11 within the debris holding tank, can travel over the front edge 20 of the air distributing manifold, and is guided by the air distributing manifold towards the air exit aperture.

According to embodiments, the lower plate is configured to be wider at the front edge and decreases in width along its length to the air exit aperture. The side plates positioned along the lower plate are configured to compress the air flow, thereby reducing the speed thereof, thus further causing entrained debris to precipitate out of the airflow and onto the lower plate. Due to the slope of the lower plate this precipitated debris can be guided and travel towards the main portion of the debris holding tank. It would he readily understood that the lower plate of the air distribution manifold may have a varying slope over it length. For example the lower plate can have a curved slope over its length or the slope can have one or more discrete slope changes over the length of the lower plate.

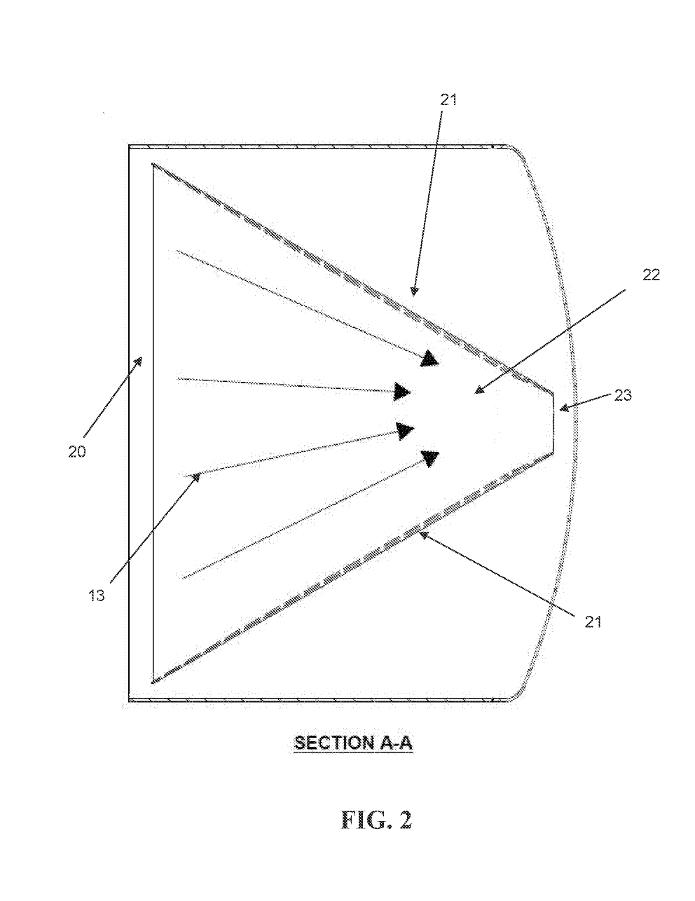

FIG. 2 illustrates an embodiment of the air distributing manifold in accordance with embodiments of the present invention. As illustrated, as the air flow enters the air distributing manifold via the front edge 20, the air flow 13 is compressed towards the exit end 23 of the air distributing manifold. This compression of the air flow is provided by the side plates 21 together with the configuration of the lower plate which has a decreasing width further away from the front edge thereof. This compression of the air flow results in the decrease in the velocity of the air flow and enables further precipitation of debris which is entrained within the air flow.

According to embodiments, the width reduction of the lower plate along its length can be determined based on the desired level of compression and resulting reduction in air flow velocity, such that a desired level of debris precipitation is enabled from the air flow, as well as a desired level of air volume movement into and out of the debris storage tank is provided. It would be readily understood that if the air flow is decreased to a particular level, the volume of air entering the debris storage tank may be greater than the air exiting the debris storage tank and after a period of time this can result in an increase in the pressure within the tank which may potentially reduce the operational characteristics of the hydrovac system. These and other considerations can provide a means for determining appropriate configurations of the air distribution manifold and the configurations of the components thereof.

According to embodiments, the lower plate can be configured as a flat plate, a curved plate, a multi-slope plate or other configuration as would be readily understood by a worker skilled in the art. For example, the lower plate can have a “V” shape, wherein the vertex of the “V” is aligned along the length of the lower plate. In this type of configuration, the debris that precipitates from the air flow on the lower plate of the air distribution manifold may move to the centre of the lower plate which may enhance the movement of the debris off of the lower plate and into the main portion of the debris storage tank.

According to embodiments, the front edge of the lower plate can have non-linear configurations, for example the front edge can have a concave shape curving towards the exit end of the air filtering device. In some embodiments, this front edge can be “V” shaped with the vertex of the “V” being closer to the exit end. Other curvilinear shapes of the front edge are also possible as would be readily understood by a worker skilled in the art.

According to embodiments, the length of the lower plate, namely the distance that the lower plate protrudes from the air exit aperture can be dependent on the size of the debris storage tank or the desired level of recirculation within the debris holding tank or both. For example, if the lower plate is too long, the air distributing manifold may inhibit the desired level of recirculation of the air flow within the tank to a smaller volume of the debris holding tank when compared with a lower plate which is shorter in length. It would be readily understood that the specific length of the lower plate can be determined through experimentation with a particular debris holding tank, in order that the desired level of recirculation of the air flow can be provided.

According to embodiments, the side plates of the air distributing manifold can be connected to the lower plate such that these side plates are substantially perpendicular to the lower plate. in other embodiments, the plates are aligned with the lower plate at a more obtuse angle, resulting in the side plates being spaced further apart at a location away from the lower plate. The configuration and alignment of the side plates relative to the lower plate can be dependent on the desired effect that the air distributing manifold has on the recirculation of the air within the debris storage tank.

In some embodiments the side plates are rectangular in their side profile or the side profile may be an alternate shape. The shape of the side plates can be dependent on the desired effect that the air distributing manifold has on the recirculation of the air within the debris storage tank. In some embodiments, as illustrated in FIG. 1, the side plates can have a relatively small height proximate to the front edge 20 of the air distributing manifold and a larger height at locations removed from the front edge. In some embodiments, the change in the height of the side plates can change in a curvilinear nature along the length of the side plate or the change in the height of the side plates can be in a stepwise nature along the length of the side plate.

According to embodiments, the air distributing manifold can be configured to be installed in the debris storage tank upon initial fabrication of the tank, or alternately the air distributing manifold can be configured such that it can be a modification to an existing debris storage tank. For example for a modification installation of the air distributing manifold, the air distributing manifold may be connected to the debris storage tank by bolting or other connection means that may be readily performed in the field.

It is readily understood that while the above description of the air distributing manifold according to embodiments of the present invention has be integrated into a hydrovac tank configured as a dual function tank, which further includes a sloped floor which separates the debris storage tank compartment from the water storage tank compartment, the air distributing manifold can be integrated into other hydrovac tank configurations. It would be readily understood that the air filtering device according to embodiments of the present invention, can be integrated into a dual function tank with a substantially flat floor separating the debris storage tank compartment from the water storage tank compartment. Moreover, the air filtering device according to embodiments of the present invention can be integrated into a single function tank, namely a debris storage tank. These and other tank configurations where there is a need for debris removal from an air flow having this debris entrained therein, may also have an air distributing manifold in accordance with embodiments of the present invention integrated therein and are considered to be within the scope of the present disclosure.

According to embodiments, for a hydrovac system, the air distribution manifold can provide a means for additional removal of particulate entrained within the air flow prior to this air flow exiting the debris storage tank. This further cleaning of the air flow can enable the elimination or reduction of further filtration systems to be integrated into the hydrovac system, thereby reducing costs of fabrication due to the reduction of components. The elimination or reduction of further filtration systems for the hydrovac system may further reduce operational costs, for example fuel costs and/or other costs associated with the operation of larger filtration systems.

It is obvious that the foregoing embodiments of the invention are examples and can be varied in many ways. Such present or future variations are not to be regarded as a departure from the spirit and scope of the invention, and all such modifications as would he obvious to one skilled in the art are intended to be included within the scope of the following claims.

1. An air distributing manifold for a hydrovac tank having an entry aperture and an air exit aperture, the air distributing manifold comprising:
a lower plate having a length and a width, wherein the width decreases over the length of the lower plate;
two side plates coupled to opposite sides of the lower plate, the side plates configured to compress air flowing along the length of the lower plate;
wherein an exit end of the lower plate is narrow relative to a front edge of the lower plate and is positioned proximate to the air exit aperture and the lower plate extends into an interior of the hydrovac tank.

2. The air distributing manifold according to claim 1, wherein the lower plate is sloped such that the exit end of the lower plate is elevated relative to the front edge of the lower plate.

3. The air distributing manifold according to claim 1, wherein the front edge of the lower plate is curved or linear.

4. (canceled)

5. The air distributing manifold according to claim 1, wherein at least one side plate is perpendicular to the lower plate.

6. (canceled)

7. (canceled)

8. The air distributing manifold according to claim 1, wherein at least one side plate has a side profile wherein the side profile changes along the length of the side plate.

9. The air distributing manifold according to claim 8, wherein the side profile changes as a curve along the length of the side plate.

10. (canceled)
